(19) United States
(12) Patent Application Publication
(10) Pub. No.: US 2005/0180347 A1
(43) Pub. Date: Aug. 18, 2005

(54) METHOD FOR IP ADDRESS ALLOCATION

(76) Inventor: Heng-Chien Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,201

(22) Filed: Feb. 16, 2004

(51) Int. Cl. H04Q 7/00

(52) U.S. Cl. 370/313; 370/349

(57) ABSTRACT

A method for IP address allocation of an IP-based extension includes connecting the IP-based extension to a network private branch exchange (NPBX) host and the NPBX host allocating an IP address to the IP-based extension only when the IP-based extension is connected to the NPBX host. Two connecting ways for the IP-based extension connecting to the NPBX host are through a network cable and through the Internet. Through the network cable, the IP-based extension directly downloads/uploads information from/to the NPBX host. Through the Internet, the IP-based extension keys in the static IP address of the NPBX host, selects a security level, and keys in a password to download/upload information from/to the NPBX host.

### BACKGROUND OF INVENTION

1. Field of the Invention

The present invention relates to a method for IP address allocation, and more particularly, to a method for IP address allocation which is accomplished when an IP-based extension connects to a host.

2. Description of the Prior Art

With the popularity of Internet connections, many IP-based applications are developed, such as Voice over Internet Protocol (VoIP) and so forth. Each terminal in such applications connects to the Internet through a physical IP address, which is provided by an Internet Service Provider (ISP). However, it is hard to move the fixed IP address if the terminal is moved to another place. In addition, the ISP must make efforts to allocate the IP address of each terminal and to maintain the connection of each terminal.

### SUMMARY OF INVENTION

It is therefore a primary objective of the claimed invention to provide a method for IP address allocation to solve the above-mentioned problem.

According to the claimed invention, a method for IP address allocation of an IP-based extension comprises connecting the IP-based extension to a network private branch exchange (NPBX) host, and the NPBX host allocating an IP address to the IP-based extension only when the IP-based extension is connected to the NPBX host.

It is an advantage of the claimed invention that the method for IP address allocation is accomplished only when the IP-based extension is connected to the NPBX host through network cables or the Internet so that the ISP reduces the complexities of allocating IP addresses and maintaining the connections.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an IP-based network according to the present invention.

FIG. 2 is a flow chart of IP address allocation for the IP-based extensions according to the present invention.

FIG. 3 is a flow chart of IP address allocation for the IP-based extensions according to the present invention.

### DETAILED DESCRIPTION

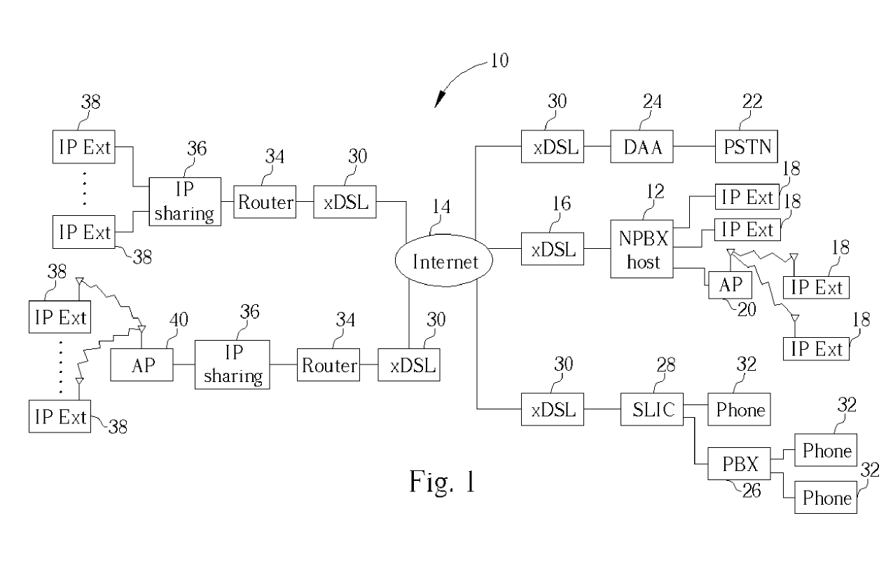

Please refer to FIG. 1. FIG. 1 is a block diagram of an IP-based network 10 according to the present invention. The IP-based network 10 connects a NPBX host 12 to the Internet 14 through an Internet connection 16, such as an XDSL connection or another suitable broadband Internet connection. The Internet connection 16 provides a static IP address to the NPBX host 12. A plurality of IP-based extensions 18 are electrically connected to the NPBX host 12 through network cables according to the IEEE 802.3 protocol or through an access point (AP) 20 according to the IEEE 802.11 protocol. In addition, the IP-based network 10 connects a public switched telephone system (PSTN) 22 to the Internet 14 through a data access arrangement (DAA) module 24, and connects a private branch exchange (PBX) 26 to the Internet 14 through a subscriber line interface circuit (SLIC) module 28. The DAA module 24 and the SLIC module 28 convert voice signals to voice packets for transmitting to the Internet 14 as well as convert voice packets to voice signals for transmitting to the PSTN 22 and PBX 26 through a plurality of Internet connections 30. Each of the Internet connections 30 is an xDSL or another broadband Internet connection, providing a physical IP-address to the DAA module 24 or SLIC module 28. A plurality of normal telephones 32 are also connected to the Internet 14 through the PBX 26 as well as the SLIC module 28. The NPBX host 12 controls packet transmission of the DAA module 24 and the SLIC module 28.

As shown in the left part of FIG. 1, a plurality of IP-based extensions 38 are connected to the Internet 14 through a plurality of routers 34 and a plurality of IP sharing devices 36. The routers 34 are connected to the Internet 14 through the Internet connections 30. The IP-based extensions 38 are electrically connected to the IP sharing devices 36 through network cables according to the IEEE 802.3 protocol or connected to an access point 40 according to the IEEE 802.11 protocol. The IP-based extensions 18 are connected to the NPBX host 12 in an intra network, while the IP-based extensions 38 are connected to the NPBX host 12 through the Internet 14. A plurality of IP addresses of the IP-based extensions 18 and 38 are allocated by the NPBX host 12 only when the IP-based extensions 18 and 38 are connected to the NPBX host 12.

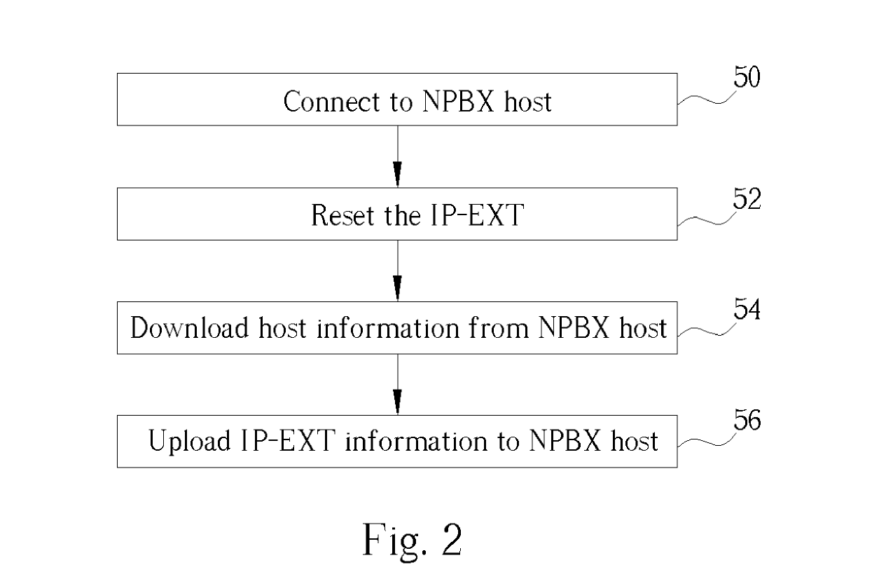

Please refer to FIG. 2. FIG. 2 is a flow chart of IP address allocation for the IP-based extensions 18 according to the present invention. The flow chart includes the following steps:
Step 50: each IP-based extension 18 is connected to a port of the NPBX host 12 through a network cable;
Step 52: the NPBX host resets each IP-based extension 18;
Step 54: each of the IP-based extensions 18 downloads information from the port of the NPBX host 12, including the static IP address of the NPBX 12, the physical IP allocated by the NPBX host 12 for the IP-based extensions 18, information of the DAA module 24, the SLIC module 28 as well as the AP 20, and data of the medium access control (MAC) layer in the transmission protocol; and
Step 56: each of the IP-based extension 18 uploads information to the port of the NPBX host 12, including data of the medium access control (MAC) layer in the transmission protocol.

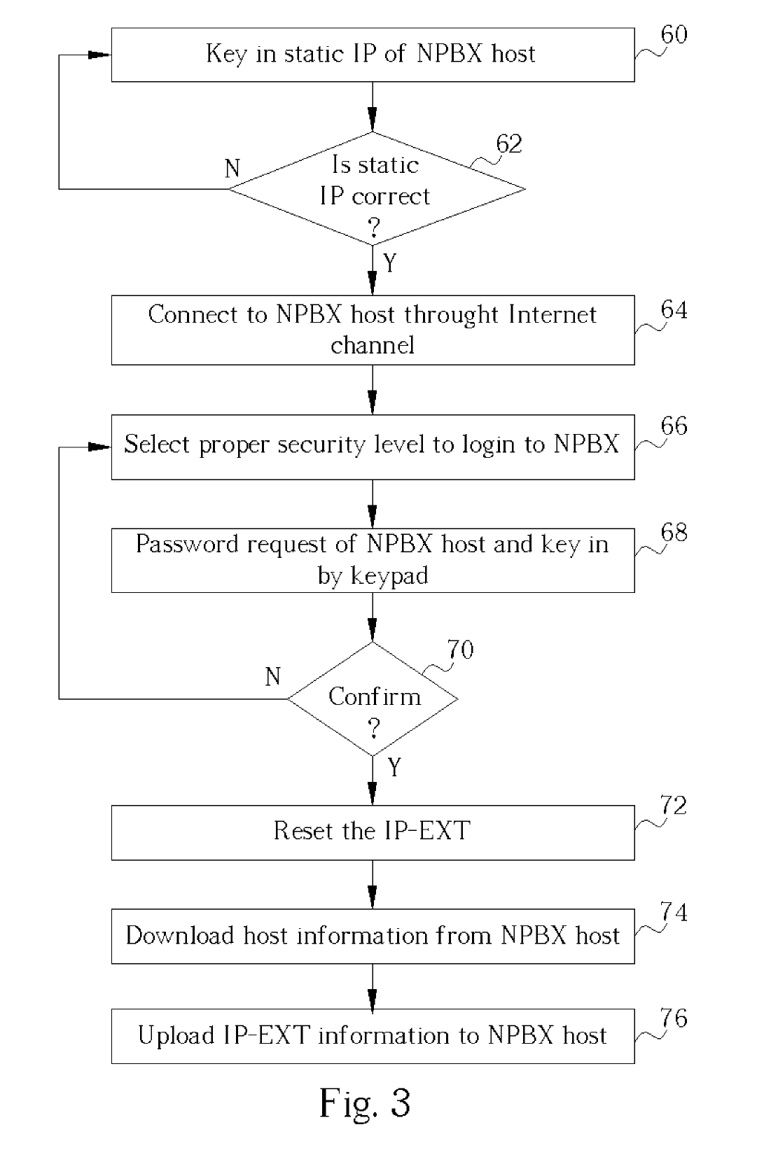

Please refer to FIG. 3. FIG. 3 is a flow chart of IP address allocation for the IP-based extensions 38 according to the present invention. The flow chart includes the following steps:
Step 60: users of each IP-based extension 38 key in the static IP address of the NPBX host 12 to make each IP-based extension 38 connect to the NPBX host 12 through the Internet 14;
Step 62: the NPBX host 12 checks if the static IP address keyed in by the users of each IP-based extension 38 is correct, going to step 64 if it is correct or returning to step 60 if it is not correct;
Step 64: the connections between the NPBX host 12 and the IP-based extensions 38 are built through the Internet 14;
Step 66: users of each IP-based extension 38 respectively select proper security levels to login to the NPBX host 12;
Step 68: the NPBX host 12 sends a password request to each IP-based extension 38, and users of each IP-based extension 38 key in a password by the keypads;
Step 70: the NPBX host 12 checks if the password keyed in by the users of each IP-based extension 38 is correct, going to step 72 if it is correct or returning to step 66 if it is not correct;
Step 72: the NPBX host 12 resets each IP-based extension 38;
Step 74: each of the IP-based extensions 38 downloads information from the NPBX host 12 through the Internet 14, including the static IP address of the NPBX 12, the physical IP allocated by the NPBX host 12 for the IP-based extensions 38, information of the DAA module 24, the SLIC module 28 as well as the AP 20, and data of the medium access control (MAC) layer in the transmission protocol; and
Step 76: each of the IP-based extension 38 uploads information to the NPBX host 12 through the Internet 14, including data of the medium access control (MAC) layer in the transmission protocol.

Two ways for IP address allocation of the IP-based extensions are shown in FIG. 2 and FIG. 3. In FIG. 2, the IP-based extensions physically connect to the NPBX host through network cables at first, which makes sure connection security to download/upload information from/to the NPBX host. In FIG. 3, the IP-extensions connect to the NPBX host through the Internet, which requires additional steps for solving the problems of low security of the Internet, including keying in the static IP address to connect to the NPBX host, selecting proper security levels to login, and keying in the passwords to download/upload information from/to the NPBX host.

In contrast to the prior art, the present invention method for IP address allocation is accomplished only when the IP-based extension is connected to the NPBX host through network cables or the Internet so that the ISP reduces the complexities of allocating IP address and maintaining the connections.

Those skilled in the art will readily observe that numerous modifications and alterations of the device may be made while retaining the teachings of the invention. Accordingly, that above disclosure should be construed as limited only by the metes and bounds of the appended claims.

1. A method for IP address allocation of an IP-based extension, the method comprising:
connecting the IP-based extension to a network private branch exchange (NPBX) host, the NPBX host being connected to the Internet through a static IP address; and
the NPBX host allocating an IP address to the IP-based extension only when the IP-based extension is connected to the NPBX host.

2. The method of claim 1 wherein the NPBX host resets the IP-based extension after the IP-based connects to the NPBX host.

3. The method of claim 1 wherein the IP-based extension is connected to the NPBX host through a network cable according to the IEEE 802.3 protocol.

4. The method of claim 1 wherein the IP-based extension is wirelessly connected to the NPBX host through an access point according to the IEEE 802.11 protocol.

5. The method of claim 1 wherein the IP-based extension is connected to the NPBX host through the Internet.

6. The method of claim 5 wherein the IP-based extension is connected to the Internet through a network cable according to the IEEE 802.3 protocol.

7. The method of claim 5 wherein the IP-based extension is wirelessly connected to the Internet through an access point according to the IEEE 802.11 protocol.

8. The method of claim 5 wherein users key in the IP address of the NPBX host, select a security level, and key in a password to confirm the connection between the NPBX host and the IP-based extension.

9. The method of claim 1 wherein when the IP-based extension is connected to the NPBX host, the IP-based extension downloads information from the NPBX host and uploads information to the NPBX host.

10. The method of claim 9 wherein the IP-based extension downloads the IP address allocated by the NPBX host, the static IP address of the NPBX host, and data of the medium access control (MAC) layer in the transmission protocol from the NPBX host.

11. The method of claim 9 wherein the IP-based extension uploads data of the MAC layer in the transmission protocol to the NPBX host.
